(19) United States
(12) Patent Application Publication
(10) Pub. No.: US 2024/0397940 A1
(43) Pub. Date: Dec. 5, 2024

(54) COMPOSITIONS COMPRISING A SATURATED OR UNSATURATED ALIPHATIC ACID AND A NON-IONIC SURFACTANT FOR ENHANCING PENETRATION OF PESTICIDE COMPONENT

(71) Applicant: TERRAMERA, INC., Vancouver (CA)

(72) Inventors: Annett ROZEK, Port Moody (CA); Hangsheng LI, Vancouver (CA); Richel Sze Heng POON, Surrey (CA); Miao ZHANG, Vancouver (CA); Zhijing WAN, Vancouver (CA)

(21) Appl. No.: 18/694,199

(22) PCT Filed: Sep. 21, 2022
(86) PCT No.: PCT/CA2022/051401

§ 371 Date: Mar. 21, 2024

Related U.S. Application Data
(60) Provisional application No. 63/246,737, filed on Sep. 21, 2021.

(51) Int. Cl. A01N 25/30; A01N 43/54; A01N 43/653; A01N 47/24

(52) U.S. Cl. CPC A01N 25/30; A01N 43/54; A01N 43/653; A01N 47/24

(57) ABSTRACT

Enhanced pesticidal compositions as well as adjuvants and methods for enhancing pesticidal compositions are provided. Combinations of adjuvants and aliphatic acids which, in combination, can provide improved penetration of aliphatic acids and/or pesticidal active ingredients through waxy plant cuticles (e.g. leaf cuticles) are provided. The adjuvants may comprise non-ionic surfactants, such as ethoxylated fatty alcohols and/or alky aryl polyethoxy late. The aliphatic acids may comprise C4-C12 saturated or unsaturated aliphatic acids, such as trans-2-hexenoic acid, trans-3-hexenoic acid, 5-hexenoic acid, and/or 3-nonenoic acid. The pesticidal active ingredients may comprise strobilurins, and/or azoles, such as pyraclostrobin, azoxystrobin, epoxiconazole, and/or prothioconazole.

### CROSS-REFERENCE TO RELATED APPLICATIONS

This application claims priority to, and the benefit of, U.S. provisional patent application No. 63/246,737 filed 21 Sep. 2021, the entirety of which is incorporated by reference herein for all purposes.

### TECHNICAL FIELD

The present disclosure relates generally to pesticidal compositions, and particularly to compositions for enhancing physical characteristics of pesticidal compositions, such as those related to the storage, mixing, transportation, application, and/or efficacy of the pesticidal composition in, e.g., agricultural, horticultural or household pest control contexts.

### BACKGROUND

Pesticides, including fungicides, herbicides, nematicides and insecticides, are important compositions for use in domestic, agricultural, industrial and commercial settings, such as to provide for control of unwanted pests and/or pathogens. Pesticidal compositions can be mixed with further ingredients prior to application, such as solvents, carriers, and/or adjuvants (e.g. activators, spreaders, stickers, emulsifiers, penetrants, etc.), e.g. to affect the physical characteristics of the resulting formulation.

In some circumstances pesticides are delivered through a plant leaf cuticle to control a pest plant and/or to be distributed, such as systemically distributed, within a host organism to protect it from a pest. For example, fungal infection in many plants, including many crop plant species, quickly progresses by breaking through the plant leaf cuticle and spreading below the leaf surface such as into the mesophyll. Fungicides may be applied to the leaf cuticle, in which case their active ingredients must penetrate through the plant leaf cuticle to reach the fungal mycelium and control fungal growth.

Many active ingredients, and particularly pesticidal active ingredients, do not readily penetrate through the waxy plant leaf cuticle. Ethoxylated fatty alcohols, which can be members of a class of adjuvant sometimes called “accelerators”, can aid the penetration of hydrophobic active ingredients by acting as plasticizers of the waxy portion of the plant leaf cuticle. Commercially-available adjuvants comprising ethoxylated fatty alcohols include Biosoft®) (available from Stepan Company, Northfield, IL, USA) and Freeway® (available from Loveland Products, Loveland, CO, USA).

Synergistic compositions comprising pesticidal active ingredients and certain saturated and unsaturated aliphatic acids have recently been discovered, e.g. as disclosed in PCT Patent Applications No. PCT/IB2018/057598 and No. PCT/IB2018/057597. As described therein, in such synergistic pesticidal compositions, such aliphatic acids are believed to act as cell permeabilizing agents, allowing pesticidal active ingredients to pass more easily through certain biological membranes, such as pest cell membranes for example.

There is a general desire for pesticidal compositions with improved delivery of pesticidal active ingredients and/or synergistic complexes, efficacy thereof, and/or other characteristics.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides pesticidal compositions and methods for making them (e.g. by combining the components) comprising: a pesticidal active ingredient selected from the group consisting of: a triazole fungicide, a strobilurin fungicide, a spinosyn insecticide, and combinations thereof: a saturated or unsaturated aliphatic acid; and an ethoxylated fatty alcohol surfactant.

In some embodiments, the pesticidal active ingredient may comprise azoxystrobin, pyraclostrobin, and/or a triazole (such as prothioconazole and/or epoxiconazole). The non-ionic surfactant may comprise a linear alcohol ethoxylate, such as a C10-C18 linear alcohol ethoxylate. In a more particular embodiment, the non-ionic surfactant may comprise a C11-C14 linear alcohol ethoxylate, and in a particular such embodiment, the non-ionic surfactant may particularly comprise a C11 linear alcohol ethoxylate, such as for example a Biosoft® N1 series surfactant produced by the Stepan Company: particularly such as Biosoft® N1-5, Biosoft®) N1-7, and Biosoft® N1-9 surfactants. The non-ionic surfactant may alternatively, or in addition, comprise an alky aryl polyethoxylate, such as Agral® 90 and/or Triton™ X-100. The saturated or unsaturated aliphatic acid may comprise a C4-C12 saturated or unsaturated aliphatic acid. The C4-C12 saturated or unsaturated aliphatic acid may comprise at least one of: (a) a trans-2, trans-3, trans-4, trans-5, trans-6, trans-7, trans-8, and trans-9, trans-10, trans-11, cis-2, cis-3, cis-4, cis-5, cis-6, cis-7, cis-8, cis-9, cis-10, cis-11 unsaturated bond: (b) a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, a decynoic acid. The C4-C12 saturated or unsaturated aliphatic acid may comprise at least one of: trans-2-hexenoic acid, trans-3-hexenoic acid, 5-hexenoic acid, and 3-nonenoic acid.

In some embodiments, the saturated or unsaturated aliphatic acid may be in a range of at least one of: 10 to 10,000, 100 to 10,000, 500 to 10,000, 1,000 to 10,000, 1,500 to 10,000, 10 to 9,000, 100 to 9,000, 500 to 9,000, 1,000 to 9,000, 1,500 to 9,000, 10 to 8,000, 100 to 8,000, 500 to 8,000, 1,000 to 8,000, 1,500 to 8,000, 10 to 7,000, 100 to 7,000, 500 to 7,000, 1,000 to 7,000, 1,500 to 7,000, 10 to 6,000, 100 to 6,000, 500 to 6,000, 1,000 to 6,000, 1,500 to 6,000, 10 to 5,000, 100 to 5,000, 500 to 5,000, 1,000 to 5,000, 1,500 to 5,000, 10 to 4,000, 100 to 4,000, 500 to 4,000, 1,000 to 4,000, 1,500 to 4,000, 10 to 3,000, 100 to 3,000, 500 to 3,000, 1,000 to 3,000, 1,500 to 3,000, 10 to 2,500, 100 to 2,500, 500 to 2,500, 1,000 to 2,500, 1,500 to 2,500, 10 to 2,000, 100 to 2,000, 500 to 2,000, 1,000 to 2,000, 1,500 to 2,000, 10 to 1,500, 100 to 1,500, 500 to 1,500, 1,000 to 1,500, 10 to 1,000, 100 to 1,000, 500 to 1,000, 10 to 500, and 100 to 500, ppm of the pesticidal composition. In some embodiments, the saturated or unsaturated aliphatic acid may be in a range of 500 to 3,500 ppm of the pesticidal composition. In some embodiments, the saturated or unsaturated aliphatic acid may be in a range of 500 to 1,500 ppm of the pesticidal composition.

In certain embodiments, a concentration ratio of pesticidal active ingredient to saturated or unsaturated aliphatic acid may be in a range of about 1:100 to 1.5:1 by weight. The concentration ratio of pesticidal active ingredient to saturated or unsaturated aliphatic acid may be in a range of about 1:10 to 1:1 by weight. A concentration ratio of saturated or unsaturated aliphatic acid to ethoxylated fatty alcohol surfactant may be in a range of about 1:10 to 100:1 by weight. The concentration ratio of saturated or unsaturated aliphatic acid to ethoxylated fatty alcohol surfactant may be in a range of about 1:1 to 10:1 by weight.

According to some embodiments of the present invention, a pesticidal composition may be provided, comprising at least one of: a solution, an emulsion, and an emulsifiable concentrate. The saturated or unsaturated aliphatic acid may be mixed with a pre-mixed mixture of the pesticidal active ingredient and the non-ionic surfactant. A pre-mixed mixture of the saturated or unsaturated aliphatic acid and the non-ionic surfactant may be mixed with the pesticidal active ingredient. A pre-mixed mixture of the saturated or unsaturated aliphatic acid and pesticidal active ingredient may be mixed with the non-ionic surfactant.

In some embodiments, making the pesticidal composition comprises selecting the ethoxylated fatty alcohol to increase penetration of at least one of: the pesticidal active ingredient and the saturated or unsaturated aliphatic acid through a cuticle, such as a waxy leaf cuticle, of the at least one plant.

Aspects of the present disclosure provide pesticidal compositions comprising: a pesticidal active ingredient comprising at least one of: pyraclostrobin and epoxiconazole at a concentration of about 10 to 500 ppm: an aliphatic acid comprising at least one of: 5-Hexenoic acid and 3-Nonenoic acid at a concentration of about 100 to 5,000 ppm; and a surfactant comprising a linear alcohol ethoxylate at a concentration of about 100 to 5,000 ppm.

The pesticidal active ingredient may comprise pyraclostrobin at a concentration of about 100 to 250 ppm and the aliphatic acid may comprise 5-Hexenoic acid at a concentration of about 500 to 1,500 ppm. The pesticidal active ingredient may comprise epoxiconazole at a concentration of about 10 to 200 ppm and the aliphatic acid may comprise 3-Nonenoic acid at a concentration of about 500 to 1,500 ppm.

Aspects of the present disclosure provide methods for applying a pesticidal composition to control at least one plant pest. The method comprises: making a pesticidal composition comprising a pesticidal active ingredient, a saturated or unsaturated aliphatic acid, and a non-ionic surfactant as disclosed elsewhere herein; and applying the pesticidal composition to at least one plant, the locus thereof, or propagation material thereof, which is susceptible to or infested with the at least one plant pest.

The pesticidal active ingredient and the saturated or unsaturated aliphatic acid may be operable to form a complex with synergistic efficacy against the at least one plant pest. In some embodiments, methods of applying a pesticidal composition to control at least one plant pest may comprise selecting the non-ionic surfactant to increase penetration of at least one of the pesticidal active ingredient and the saturated or unsaturated aliphatic acid through a cuticle, such as a waxy leaf cuticle, of the at least one plant.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a chart showing rates of disease infection of crown rust (P. coronata) in plots of oats following treatment by various pesticidal compositions at various concentrations in a field trial.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Definitions

Unless defined otherwise, all technical and scientific terms used herein have the same meaning as commonly understood by one of ordinary skill in the art to which this disclosure belongs. As used herein, singular forms include plural references unless the context clearly dictates otherwise. As used herein, “comprises” or “comprising” are to be interpreted in their open-ended sense, i.e. as specifying that the stated features, elements, steps or components referred to are present, but not excluding the presence or addition of further features, elements, steps or components.

As used herein, all numerical values or numerical ranges provided expressly include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. Therefore, as used herein, where a range of values is provided, it is understood that each intervening value between the upper and lower limit of that range and any other stated or intervening value within that stated range is encompassed within embodiments of the disclosure. The upper and lower limits of these smaller ranges may independently define a smaller range of values, and it is to be understood that these smaller ranges are intended to be encompassed within embodiments of the disclosure, subject to any specifically excluded limit in the stated range.

As used herein, the terms “pesticide” or “pesticidal” or grammatical equivalents thereof, are understood to refer to any composition or substance that can be used in the control of any agricultural, natural environmental, and domestic/household pests. The terms “control” or “controlling” are meant to include, but are not limited to, any killing, inhibiting, growth regulating, or pestistatic (inhibiting or otherwise interfering with the normal life cycle of the pest) activities of a composition against a given pest. These terms include for example sterilizing activities which prevent the production or normal development of seeds, ova, sperm or spores, cause death of seeds, sperm, ova or spores, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, interfering with mycelial growth, reducing gut motility, inhibiting the formation of chitin, disrupting mating or sexual communication, preventing feeding (antifeedant) activity, and interfering with location of hosts, mates or nutrient-sources. The term “pesticide” includes fungicides, herbicides, nematicides, insecticides and the like. The term “pesticide” encompasses, but is not limited to, naturally occurring compounds as well as so-called “synthetic chemical pesticides” having structures or formulations that are not naturally occurring, where pesticides may be obtained by various means including, but not limited to, extraction from biological sources, chemical synthesis of the compound, and chemical modification of naturally occurring compounds obtained from biological sources.

As used herein, the terms “control” or “controlling” or grammatical equivalents thereof, are understood to encompass any pesticidal (killing) activities or pestistatic (inhibiting, repelling, deterring, and generally interfering with pest functions to prevent the damage to the host plant) activities of a pesticidal composition against a given pest. Thus, the terms “control” or “controlling” or grammatical equivalents thereof, not only include killing, but also include such activities as repelling, deterring, inhibiting or killing egg development or hatching, inhibiting maturation or development, and chemi-sterilization of larvae or adults. Repellant or deterrent activities may be the result of compounds that are poisonous, mildly toxic, or non-poisonous to pests, or may act as pheromones in the environment.

As used herein, the term “pesticidally effective amount” generally means the amount of the inventive mixtures or of compositions comprising the mixtures needed to achieve an observable effect on growth, including the effects of necrosis, death, retardation, prevention, and removal, destruction, or otherwise diminishing the occurrence and activity of the target pest organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

### Enhanced Pesticidal Compositions

Aspects of the present disclosure provide enhanced pesticidal compositions as well as adjuvants and methods for enhancing pesticidal compositions. In particular, the present disclosure provides combinations of adjuvants and aliphatic acids which, in combination, can provide improved penetration of aliphatic acids and/or pesticidal active ingredients such as through plant cuticles (e.g. leaf cuticles) and more particularly, through waxy plant leaf cuticles. In some embodiments, the adjuvants comprise non-ionic surfactants, such as ethoxylated fatty alcohol surfactants (such as those marketed under the name Biosoft®, e.g. the Biosoft®; N1 series) and/or an alky aryl polyethoxylate (such as those marketed under the name Triton™ X-100 and/or Agral® 90). In some embodiments, the aliphatic acids comprise C4-C12 saturated or unsaturated aliphatic acids, and in some further embodiments the aliphatic acids may more particularly comprise C6-C10 saturated or unsaturated aliphatic acids, such as trans-2-hexenoic acid, trans-3-hexenoic acid, 5-hexenoic acid, and/or 3-nonenoic acid. In some embodiments, the pesticidal active ingredients comprise fungicides, insecticides, herbicides, miticides, or nematicides. In some more particular embodiments, the pesticidal active ingredients may comprise QoI inhibitory fungicides, such as strobilurins and more particularly such as pyraclostrobin and azoxystrobin: or DMI fungicides such as triazoles, and more particularly such as epoxiconazole and prothioconazole.

In the case of pesticidal compositions comprising a pesticidal active ingredient and an aliphatic acid (such as those disclosed by PCT Patent Applications No. PCT/IB2018/057598 and No. PCT/IB2018/057597, incorporated for reference herein) being applied to plant cuticles, such as leaf cuticles, and more particularly such as waxy leaf cuticles, it is believed by the present inventors, without being bound by theory, that it is desirable for both the pesticidal active ingredient and the aliphatic acid to penetrate through the cuticle to reach the target pest (e.g. a fungal mycelium invading a host plant) to unfold their synergistic action.

In some embodiments, at least some synergistic complexes of pesticidal active ingredient and aliphatic acid are disclosed which desirably facilitate the penetration of the synergistic complex across waxy plant cuticles, relative to the pesticidal active ingredient alone. For instance, the non-ionic surfactant may be effective to synergistically increase penetration of the pesticidal active ingredient and/or the aliphatic acid across the waxy plant cuticle.

Without being bound by theory, it is believed that aliphatic acids traverse plant cuticles, such as leaf cuticles and particularly waxy leaf cuticles, in three ways. One is to pass through the hydrophilic passages of the leaf cuticle. Aliphatic acids are generally hydrated (surrounded by a water shell) and so tend to be preferentially transported via this passage, making it the most common mode of traversal for aliphatic acids on their own. Another mode of transport across leaf cuticles is to form a complex with pesticidal active ingredients and traverse the waxy plant cuticle as part of the complex. (Most pesticidal active ingredients are generally hydrophobic and so are most likely to traverse the waxy cuticle through such hydrophobic passages through the waxy cuticle layer.) Finally, aliphatic acids may be transported through waxy plant cuticle passages.

Though they may take different paths to enter into a plant tissue, such as to a site of disease or infestation within a plant tissue, if the pesticidal active ingredient and the aliphatic acid can both be delivered across the cuticle then the pesticidal active ingredient and the aliphatic acid can form a synergistic complex (if not already in such a complex) such as to desirably promote permeation through cellular membranes of target pests (e.g. fungal membranes of fungal pests' mycelia present in a host plant's mesophyll, or other cellular pest membranes such as those comprising a lipid bilayer membrane, for example).

The inventors have observed, through experiment, that penetration of aliphatic acids into plant tissues, such as through a waxy plant cuticle, can be reduced by the presence of a pesticidal active ingredient. For instance, leaf penetration studies of prothioconazole in combination with trans-3-Hexenoic acid applied to soybean leaves have shown that presence of prothioconazole can decrease leaf penetration of trans-3-Hexenoic acid by 30-50% relative to leaf penetration rates of trans-3-Hexenoic acid alone. Without being bound by theory, this is believed to be caused by trans-3-Hexenoic acid forming a complex with prothioconazole which is more hydrophobic than trans-3-Hexenoic acid alone, and thus preventing the penetration of trans-3-Hexenoic acid through the hydrophilic passages of the leaf. Such reductions in penetration can inhibit the formation or stability of complexes of pesticidal active ingredient and aliphatic acid within the plant tissue such as near the site of systemic plant disease infections, which can reduce pest control efficacy within plant tissues.

Certain experimental results disclosed herein are believed to support the theory that aliphatic acids promote the transport of hydrophobic pesticidal active ingredients across waxy plant cuticles. Prior to this disclosure, it is believed that this mechanism of transfer has not been understood and that its consequences—in particular the synergistic transfer of pesticidal active ingredients into plant tissues—are surprising. For instance, it is believed that the transfer of hydrophobic pesticidal active ingredients across hydrophobic passages can be effectively saturated by the addition of a penetrant, and that therefore prior to this disclosure it would not be expected that transfer of such pesticidal active ingredients could be increased beyond what is achieved by a penetrant in many circumstances. Making use of the aqueous passage for transport of such pesticidal active ingredients to achieve any increase in transport of such pesticidal active ingredients is a surprising result which is believed to be demonstrated by certain experimental results disclosed herein.

An alternative or supplementary theory, to which the present disclosure is not bound, is that certain surfactants may break up complexes formed between pesticidal active ingredients and aliphatic acids, which may stimulate transfer of one or more of the pesticidal active ingredients and aliphatic acids through the hydrophobic and hydrophilic passages, respectively. In particular, non-ionic surfactants are believed to interact with such complexes and may provide this behaviour. Certain experimental results disclosed herein are consistent with this surprising behaviour.

Compositions according to the present disclosure combine aliphatic acids with adjuvants, such as ethoxylated fatty alcohol surfactants, to increase the penetration not only of the hydrophobic active ingredients, but also of less water-soluble aliphatic acids and complexes of pesticidal active ingredients and aliphatic acids. This can, in suitable circumstances, increase the concentration of complexes of the pesticidal active ingredient and the aliphatic acid inside the host organism and allow for more effective control of pests. For instance, a greater concentration of synergistic complex of a pesticidal active ingredient and aliphatic acid may be present in a leaf and may more effectively treat fungal and/or insect pests which have invaded plant tissue and/or are feeding on it.

The experimental results set out below show that an accelerator type adjuvant compound, such as an ethoxylated fatty alcohol surfactant, can increase the penetration of a complex of a pesticidal active ingredient and an aliphatic acid through the waxy plant cuticles. This increases the probability that the complex will bind to a pest, such as a fungal pathogen cell inside the leaf, and thus more effectively control the pest. Prior to the discoveries set out herein, it was not expected that an accelerator would be needed or desired to improve penetration of aliphatic acids in such pesticidal compositions.

In some embodiments, the pesticidal active ingredient comprises a QoI inhibitory fungicide, such as a strobilurin, and more particularly such as pyraclostrobin, azoxystrobin, coumoxystrobin, enoxastrobin, flufenoxystrobin, picoxystrobin, mandestrobin, pyrametostrobin, triclopyricarb, kresoxim-methyl trifloxystrobin, dimoxystrobin, fenaminstrobin, metominostrobin, orysastrobin, and/or fluoxastrobin. Experimental data concerning pyraclostrobin and azoxystrobin as representative strobilurin fungicides are provided below.

In some embodiments, the pesticidal active ingredient comprises an azole fungicide, and may optionally comprise a triazole. Examples of azole fungicides include azoxyconazole, pyrisoxazole, oxpoconazole, triflumizole, azaconazole, bromuconazole, cyproconazole, difenoconazole, diniconazole, epoxiconazole, etaconazole, fenbuconazole, fluquinconazole, flusilazole, hexaconazole, imibenconazole, ipconazole, metconazole, penconazole, propiconazole, simeconazole, tebuconazole, tetraconazole, triticonazole, and prothioconazole. Experimental data concerning epoxiconazole and prothioconazole as representative azole fungicides are provided below.

In some embodiments, the adjuvant comprises an ethoxylated fatty alcohol surfactant, such as a linear alcohol ethoxylate. For instance, the non-ionic surfactant may comprise a C11 linear alcohol ethoxylate, such as is found in Biosoft® N1 series surfactants. In some embodiments, the non-ionic surfactant comprises Biosoft® N1-5, Biosoft® N1-7, and/or Biosoft® N1-9.

In some embodiments, the aliphatic acid comprises a saturated or unsaturated aliphatic acid. The aliphatic acid may comprise a C4-C12 saturated or unsaturated aliphatic acid, and more particularly may comprise a C6-C10 saturated or unsaturated aliphatic acid. In some embodiments the aliphatic acid may comprise a trans-2, trans-3, trans-4, trans-5, trans-6, trans-7, trans-8, trans-9, trans-10, trans-11, cis-2, cis-3, cis-4, cis-5, cis-6, cis-7, cis-8, cis-9, cis-10, and/or cis-11 unsaturated bond. The aliphatic acid may comprise a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, a decynoic acid. Experimental data concerning trans-2-hexenoic acid, trans-3-hexenoic acid, 5-hexenoic acid, and 3-nonenoic acids as representative exemplary C6-C10 aliphatic acids is provided below.

In some embodiments, the aliphatic acid is provided as a mixture of aliphatic acids, e.g. as described in greater detail in U.S. Provisional Patent Application No. 63/183,942, which is hereby incorporated by reference herein in its entirety.

In some embodiments, the saturated or unsaturated aliphatic acid is in a range of at least one of: 10 to 10,000, 100 to 10,000, 500 to 10,000, 1,000 to 10,000, 1,500 to 10,000, 10 to 9,000, 100 to 9,000, 500 to 9,000, 1,000 to 9,000, 1,500 to 9,000, 10 to 8,000, 100 to 8,000, 500 to 8,000, 1,000 to 8,000, 1,500 to 8,000, 10 to 7,000, 100 to 7,000, 500 to 7,000, 1,000 to 7,000, 1,500 to 7,000, 10 to 6,000, 100 to 6,000, 500 to 6,000, 1,000 to 6,000, 1,500 to 6,000, 10 to 5,000, 100 to 5,000, 500 to 5,000, 1,000 to 5,000, 1,500 to 5,000, 10 to 4,000, 100 to 4,000, 500 to 4,000, 1,000 to 4,000, 1,500 to 4,000, 10 to 3,000, 100 to 3,000, 500 to 3,000, 1,000 to 3,000, 1,500 to 3,000, 10 to 2,500, 100 to 2,500, 500 to 2,500, 1,000 to 2,500, 1,500 to 2,500, 10 to 2,000, 100 to 2,000, 500 to 2,000, 1,000 to 2,000, 1,500 to 2,000, 10 to 1,500, 100 to 1,500, 500 to 1,500, 1,000 to 1,500, 10 to 1,000, 100 to 1,000, 500 to 1,000, 10 to 500, and 100 to 500 ppm of the pesticidal composition. In some embodiments, the saturated or unsaturated aliphatic acid is in a range of 500 to 3,500 ppm of the pesticidal composition. In some embodiments, the saturated or unsaturated aliphatic acid is in a range of 500 to 1,500 ppm of the pesticidal composition.

In some embodiments, a concentration ratio of pesticidal active ingredient to aliphatic acid is in a range of about 1:100 to 1.5:1 by weight. In some embodiments, the concentration ratio of pesticidal active ingredient to saturated or unsaturated aliphatic acid is in a range of about 1:10 to 1:1 by weight.

In some embodiments, a concentration ratio of aliphatic acid to ethoxylated fatty alcohol surfactant is in a range of about 1:10 to 100:1 by weight. In some embodiments, the concentration ratio of saturated or unsaturated aliphatic acid to ethoxylated fatty alcohol surfactant is in a range of about 1:1 to 10:1 by weight.

The pesticidal compositions according to this disclosure may be provided as solutions, emulsions, suspension concentrates, and/or emulsifiable concentrates, as described in greater detail below. Compositions comprising only a portion of these may also, or alternatively, be provided. For example, a solution, emulsion, suspension concentrate, and/or emulsifiable concentrate of an aliphatic acid and an ethoxylated fatty alcohol may be provided as a “tank mix”, to be added to and mixed with a formulation comprising a pesticidal active ingredient. As another example, a solution, emulsion, suspension concentrate, and/or emulsifiable concentrate of two or more of: an aliphatic acid, an ethoxylated fatty alcohol, and a pesticidal active ingredient may be provided as a “pre-mix”, to be added to and mixed with a formulation comprising further ingredients. Such tank-mix and/or pre-mix compositions may have relatively higher concentrations of aliphatic acid and/or ethoxylated fatty alcohol (and/or pesticidal active ingredient, in the case of pre-mixes) than would ordinarily be provided in a pesticidal composition suitable for application (which may comprise, e.g., a concentrate which has been diluted.) For instance, in some embodiments, a concentration of the saturated or unsaturated aliphatic acid is in a range of 1% to 90% of the composition. As another example, one, some, or each of the aliphatic acid, ethoxylated fatty alcohol, and/or pesticidal active ingredient (as appropriate) may have a concentration of 1% to 50% of the composition. Alternatively, or in addition, a solution, emulsion, suspension concentrate, and/or emulsifiable concentrate of an aliphatic acid and a pesticidal active ingredient may be provided, to which an ethoxylated fatty acid may be added.

Moreover, in some embodiments, a surprising increase in penetration of pesticidal active ingredients has also been observed, beyond what would be expected based on additive penetration-enhancing effects of aliphatic acids and adjuvants such as ethoxylated fatty alcohols. Such unexpected synergy has been observed in combinations of ethoxylated fatty alcohols with strobilurin and/or azole fungicides (such as pyraclostrobin and/or epoxiconazole) and C4-C12, and more particularly C6-C10 saturated or unsaturated aliphatic acids (such as 5-Hexenoic acid and/or 3-Nonenoic acid). Further experimental data is provided below.

Accordingly, in some embodiments, the pesticidal composition comprises a pesticidal active ingredient comprising at least one of: pyraclostrobin and epoxiconazole at a concentration of about 10 to 500 ppm, an aliphatic acid comprising at least one of: 5-Hexenoic acid and 3-Nonenoic acid at a concentration of about 100 to 5,000 ppm, and a surfactant comprising a linear alcohol ethoxylate at a concentration of about 100 to 5,000 ppm. For example, in some embodiments the pesticidal active ingredient comprises pyraclostrobin at a concentration of about 100 to 250 ppm and the aliphatic acid comprises 5-Hexenoic acid at a concentration of about 500 to 1,500 ppm. As another example, in some embodiments the pesticidal active ingredient comprises epoxiconazole at a concentration of about 10 to 200 ppm and the aliphatic acid comprises 3-Nonenoic acid at a concentration of about 500 to 1,500 ppm.

### Other Formulation Components

In some embodiments, when the pesticidal compositions disclosed in this disclosure are used in a formulation, such formulation may also contain other components. These components include, but are not limited to, (for greater clarity, the following is a non-exhaustive and non-mutually exclusive list) wetters, spreaders, stickers, penetrants, buffers, sequestering agents, drift reduction agents, compatibility agents, safeners, anti-foam agents, cleaning agents, rheology modifying agents, stabilizers, dispersing agents, ultraviolet light (UV) blockers, and emulsifiers. A few exemplary such additional formulation components are described below.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulphate: sodium dioctyl sulphosuccinate: alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates, and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionic surfactants such as alkylarylethylene oxide condensates and EO-PO block copolymers are sometimes combined with anionic surfactants as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant, and may comprise, for example, oligomeric polymers, comb graft copolymers, block copolymers (such as A-B-A tri-block copolymers), star polymers, and/or other polymeric surfactants. These high molecular weight polymers can give very good long-term stability to suspension concentrates because the hydrophobic backbones have many anchoring points onto the particle surfaces. Examples of dispersing agents used in agrochemical formulations are: sodium lignosulphonates: sodium naphthalene sulphonate formaldehyde condensates; tristyrylphenol ethoxylate phosphate esters: aliphatic alcohol ethoxylates: alkyl ethoxylates: EO-PO block copolymers; and graft copolymers.

An emulsifying agent is a substance which stabilizes a suspension of droplets of one liquid phase in another liquid phase. Without the emulsifying agent the two liquids would typically separate into two immiscible liquid phases. Exemplary commonly used emulsifier blends may contain alkylphenol or aliphatic alcohol with 12 or more ethylene oxide units and the oil-soluble calcium salt of dodecylbenzene sulphonic acid for example. In some embodiments, a range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. Exemplary types of surfactants usually used for solubilization include non-ionics: sorbitan monooleates: sorbitan monooleate ethoxylates; and methyl oleate esters.

Thickeners or gelling agents may be typically used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. In some examples, it is possible to produce suspension concentrate formulations using clays and silicas. Examples of these types of materials, include, but are limited to, montmorillonite, e.g. bentonite: magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum: locust bean gum: carrageenan: alginates: methyl cellulose: CMC thickeners such as sodium carboxymethyl cellulose (SCMC): hydroxyethyl cellulose (HEC). Other types of anti-settling agents are based on modified starches, polyacrylates, polyvinyl alcohol, polyethylene oxide and xanthan gum.

The presence of surfactants, which lower interfacial tension, often causes water-based formulations to foam during mixing operations in production and in application of a pesticidal composition through a spray tank. In order to reduce the tendency to foam, anti-foam agents are often added either during the production stage or before filling into bottles. Generally, there are two types of anti-foam agents, namely silicones and non-silicones. Silicones may usually comprise aqueous emulsions of dimethyl polysiloxane while the non-silicone anti-foam agents comprise water-insoluble oils, such as octanol and nonanol, or silica. In both cases, the function of the anti-foam agent is to displace the surfactant from the air-water interface. For further information on suitable such other formulation components known to those of skill in the art, reference may be made to publications such as, for example: “CHEMISTRY AND TECHNOLOGY OF AGROCHEMICAL FORMULATIONS” edited by D. A. Knowles, copyright 1998 by Kluwer Academic Publishers; and/or: “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

### Preparation

The adjuvants and/or pesticidal compositions disclosed herein may be prepared as a tank mix, a pre-mix, a combination thereof, and/or in any other suitable way. For example, in some embodiments, pesticidal compositions as disclosed herein are prepared by mixing a saturated or unsaturated aliphatic acid with a pre-mixed mixture of a pesticidal active ingredient and an ethoxylated fatty alcohol surfactant. In some embodiments, pesticidal compositions as disclosed herein are prepared by mixing a pre-mixed mixture of the saturated or unsaturated aliphatic acid and the non-ionic surfactant with the pesticidal active ingredient. In some embodiments, pesticidal compositions as disclosed herein are prepared by mixing a pre-mixed mixture of the saturated or unsaturated aliphatic acid and pesticidal active ingredient with the non-ionic surfactant. In some embodiments, pesticidal compositions as disclosed herein are prepared by forming a solution comprising the pesticidal active ingredient, the saturated or unsaturated aliphatic acid, and the ethoxylated fatty alcohol surfactant.

The adjuvants and/or pesticidal compositions disclosed herein may comprise solutions, emulsions, suspension concentrates, emulsifiable concentrates, and/or any other suitable formulation type. For example, pesticidal compositions as disclosed herein are prepared by forming at least one of: an emulsion and an emulsifiable concentrate comprising the pesticidal active ingredient, the saturated or unsaturated aliphatic acid, and the non-ionic surfactant.

### Applications

Pesticidal compositions prepared as described elsewhere herein may be applied to loci of pests and/or to host organisms (such as host plants). In some embodiments, application methods may comprise applying pesticidally effective amounts of such pesticidal compositions to at least one plant, the locus thereof, or propagation material thereof, which is susceptible to or infested with the at least one plant pest. In some further embodiments, application methods may comprise applying a pesticidally effective amount such pesticidal compositions to at least one pest plant, the locus thereof, or propagation material thereof, to control the pest plant.

### EXAMPLES

Exemplary embodiments of the present invention are further described with reference to the following examples, which are intended to be illustrative and non-limiting in nature.

The following examples make use of a novel experimental procedure for assessing penetration of compounds in the exemplary pesticidal compositions. An intact plant leaf, inclusive of the waxy plant cuticle, is held in the flat ground joint of a Franz cell. In the below-described assays, the plant leaf was selected from various plant species of interest, such as soy bean, wheat, and/or cabbage, as noted below. Isolation of the waxy leaf cuticle of such species can be undesirable or impractical (e.g. due to fragility and/or tearing of leaf tissue). A donor formulation is placed in the Franz cell's donor chamber and allowed to permeate the plant leaf. In each of the below examples, 3 mL of donor formulation was used.

During a permeation period (24 hours in each of the below examples), a portion of the donor formulation will penetrate the plant leaf's waxy cuticle on the donor chamber side. Some of the penetrating donor formulation will be retained in the leaf's tissue: some will penetrate the receptor chamber-side waxy cuticle and be deposited in the receptor chamber. At the end of the permeation period, the plant leaf, donor formulation, and receptor solution are removed from the Franz cell and analyzed to determine the quantity of donor formulation components present therein.

The quantity of a given component retained in the plant leaf was extracted by: washing the plant leaf for 20 seconds (to avoid counting any residue on the leaf surface as having penetrated the leaf membrane), freezing the plant leaf in liquid nitrogen, powderizing the frozen plant leaf with a mortar and pestle, adding 5 mL of a solvent (e.g. methanol or acetone) to the mortar to mix with the powdered leaf, transferring the mixture to a falcon tube, adding another 5 mL of the solvent to the mortar to mix with any remaining powdered leaf, and transferring the mixture to the falcon tube. The mixture in the falcon tube was then analyzed to determine the quantity of the component therein.

The penetration ratio of a component reported as penetrating the plant leaf's waxy cuticle is defined for the purposes of the below examples as the ratio of the quantity of the component in the receptor solution and plant leaf to the total quantity of the component recovered (e.g. in the donor solution, receptor solution, and plant leaf). This ratio may be expressed based on:

$$p = \frac{r + l}{r + l + d}$$

where p is the penetration ratio, r is the quantity of the component recovered from the receptor solution, l is the quantity of the component found in the leaf, and d is the quantity of the component found in the donor formulation at the end of the permeation period.

As is shown in greater detail below, pesticidal compositions of pesticidal active ingredients and aliphatic acids have now been determined experimentally to (in at least some circumstances) reduce the penetration of aliphatic acids through waxy plant cuticles, a problem which was not previously understood. As is also shown, the addition of non-ionic surfactants, such as ethoxylated fatty alcohols and/or alky aryl polyethoxylates. to such compositions can mitigate or eliminate this reduction in penetration, even though such penetrants act primarily on the waxy cuticle and are not expected to materially assist in transmission through the aliphatic acid's believed primary mode of penetration (hydrophilic passages). In some cases, aliphatic acid penetration is even improved relative to formulations of the aliphatic acid without a pesticidal active ingredient.

### Example 1

Several donor solutions were prepared to assess penetration of trans-3-Hexenoic acid across waxy cuticles of whole soybean leaves. Each donor solution comprised 1,500 ppm trans-3-Hexenoic acid. Certain donor solutions included an azole fungicide, namely prothioconazole. Such donor solutions comprised Proline®, a commercially available fungicide from Bayer CropScience comprising prothioconazole. Such donor solutions comprised 615 ppm prothioconazole. Certain donor solutions included an adjuvant as noted in Table 1, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of trans-3-Hexenoic acid in the donor solution, receptor solution, and plant leaf were analyzed as described above. The powderized leaf was mixed with methanol as a solvent.

TABLE 1

| | | | | | Penetration | |
|---|---|---|---|---|---|---|
| | Pesticidal | | | Aliphatic | Relative to | |
| | Active | Aliphatic | | Acid | Aliphatic | Expected |
| Combination | Ingredient | Acid | Adjuvant | Penetration | Acid alone | Penetration |
| | | trans-3- | | 13.7% | | |
| | | Hexenoic | | | | |
| | | acid | | | | |
| | | trans-3- | Biosoft N1-5 | 23.5% | 171.5% | |
| | | Hexenoic | | | | |
| | | acid | | | | |
| | | trans-3- | Biosoft N1-7 | 17.4% | 127.0% | |
| | | Hexenoic | | | | |
| | | acid | | | | |
| | | trans-3- | Biosoft N1-9 | 17.0% | 124.1% | |
| | | Hexenoic | | | | |
| | | acid | | | | |
| | Prothioconazole | trans-3- | | 4.6% | 33.6% | |
| | | Hexenoic | | | | |
| | | acid | | | | |
| 1 | Prothioconazole | trans-3- | Biosoft N1-5 | 19.9% | 355.4% | 57.6% |
| | | Hexenoic | | | | |
| | | acid | | | | |
| 2 | Prothioconazole | trans-3- | Biosoft N1-7 | 16.9% | 303.3% | 42.7% |
| | | Hexenoic | | | | |
| | | acid | | | | |
| 3 | Prothioconazole | trans-3- | Biosoft N1-9 | 14.7% | 262.8% | 41.7% |
| | | Hexenoic | | | | |
| | | acid | | | | |

These results support the hypothesis that prothioconazole decreases the leaf penetration of trans-3-Hexenoic acid substantially relative to trans-3-Hexenoic acid alone. Without being 5 bound by theory, it is believed that this effect is caused at least in part by forming a more hydrophobic complex (relative to trans-3-Hexenoic acid alone) and thereby preventing the penetration of trans-3-Hexenoic acid through the aqueous passages of the plant leaf cuticle.

This surprising result shows that penetration of an aliphatic acid, namely trans-3 hexenoic acid, increased more than would be expected. For example, an estimation of the form X×Y/100, where X is the penetration of trans-3-hexenoic acid in complex with prothioconazole and without an adjuvant and Y is the penetration of trans-3-hexenoic acid with an adjuvant and without prothioconazole, projects penetration in a range of approx. 42-58% of the penetration of trans-3-hexenoic acid alone (the baseline rate). The observed rate of penetration of approx. 253-355% of the baseline rate, is well in excess of that expectation.

### Example 2

Several donor solutions were prepared to assess penetration of trans-2-Hexenoic acid across waxy cuticles of whole soybean leaves. Each donor solution comprised 1,500 ppm trans-2-Hexenoic acid. Certain donor solutions included a strobilurin fungicide, namely azoxystrobin. Such donor solutions comprised Quadris®, a commercially available fungicide from Syngenta Crop Protection comprising azoxystrobin. Such donor solutions comprised 343.5 ppm azoxystrobin. Certain donor solutions included an adjuvant as noted in Table 2, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole soybean leaves was cut into roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of trans-2-Hexenoic acid in the donor solution, receptor solution, and plant leaf were analyzed as described above. The powderized leaf was mixed with methanol as a solvent.

TABLE 2

| | | | | | Penetration | |
|---|---|---|---|---|---|---|
| | Pesticidal | | | Aliphatic | Relative to | |
| | Active | Aliphatic | | Acid | Aliphatic | Expected |
| Combination | Ingredient | Acid | Adjuvant | Penetration | Acid Alone | Penetration |
| | | trans-2- | | 13.2% | | |
| | | hexenoic | | | | |
| | | acid | | | | |
| | | trans-2- | Biosoft N1-5 | 9.3% | 70.5% | |
| | | hexenoic | | | | |
| | | acid | | | | |
| | | trans-2- | Biosoft N1-7 | 9.5% | 72.0% | |
| | | hexenoic | | | | |
| | | acid | | | | |
| | | trans-2- | Biosoft N1-9 | 7.0% | 53.0% | |
| | | hexenoic | | | | |
| | | acid | | | | |
| | Azoxystrobin | trans-2- | | 13.8% | 104.5% | |
| | | hexenoic | | | | |
| | | acid | | | | |
| 1 | Azoxystrobin | trans-2- | Biosoft N1-5 | 25.3% | 191.7% | 73.7% |
| | | hexenoic | | | | |
| | | acid | | | | |
| 2 | Azoxystrobin | trans-2- | Biosoft N1-7 | 25.7% | 194.7% | 75.2% |
| | | hexenoic | | | | |
| | | acid | | | | |
| 3 | Azoxystrobin | trans-2- | Biosoft N1-9 | 21.7% | 164.4% | 55.4% |
| | | hexenoic | | | | |
| | | acid | | | | |

Penetration of the aliphatic acid, namely trans-2-hexenoic acid, increased more than would be expected. For example, an example estimation of the form X×Y/100, where X is the penetration of aliphatic acid in complex with the adjuvant and without azoxystrobin and Y is the penetration of aliphatic acid with azoxystrobin and without Biosoft, projects penetration in a range of approx. 55-75% of the penetration of 5-hexenoic acid alone (the baseline rate). The observed rate of penetration of approx. 164-195% of the baseline rate, is well in excess of that expectation.

### Example 3

Several donor solutions were prepared to assess penetration of 3-Octenoic acid across waxy cuticles of whole wheat leaves. Each donor solution comprised 500 ppm 3-Octenoic acid. Certain donor solutions included an azole fungicide, namely epoxiconazole technical grade active ingredient (TGAI) fungicide, each at a rate of 50 ppm. Epoxiconazole is commercially available from MilliporeSigma, St. Louis, MO, USA, as a technical grade active ingredient. Certain donor solutions included an adjuvant as noted in Table 3, each at a rate of 1,000 ppm. In this example, the adjuvants tested were non-ionic surfactants comprising C11 linear alcohol ethoxylates (available from Stepan Company of Northfield, IL as Biosoft® N1-5 and Biosoft®) N1-7).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of 3-Octenoic acid in the donor solution, receptor solution, and plant leaf were analyzed as described above. The powderized leaf was mixed with acetone as a solvent.

TABLE 3

| | | | | | Penetration | |
|---|---|---|---|---|---|---|
| | Pesticidal | | | Aliphatic | Relative to | |
| | Active | Aliphatic | | Acid | Aliphatic | Expected |
| Combination | Ingredient | Acid | Adjuvant | Penetration | Acid alone | Penetration |
| | | 3-octenoic | | 13.4% | | |
| | | acid | | | | |
| | | 3-octenoic | Biosoft N1-5 | 8.6% | 64.2% | |
| | | acid | | | | |
| | | 3-octenoic | Biosoft N1-7 | 7.8% | 58.2% | |
| | | acid | | | | |
| | Epoxiconazole | 3-octenoic | | 7.5% | 56.0% | |
| | | acid | | | | |
| 1 | Epoxiconazole | 3-octenoic | Biosoft N1-5 | 8.0% | 59.7% | 36.0% |
| | | acid | | | | |
| 2 | Epoxiconazole | 3-octenoic | Biosoft N1-7 | 7.9% | 59.0% | 32.6% |
| | | acid | | | | |

Penetration of the aliphatic acid, namely 3-octenoic acid, was more than would be expected. For example, an example estimation of the form X×Y/100, where X is the penetration of aliphatic acid in complex with an adjuvant and without epoxiconazole and Y is the penetration of aliphatic acid with epoxiconazole and without the adjuvant, projects penetration in a range of approx. 32-36% of the penetration of 3-octenoic acid alone (the baseline rate). The observed rate of penetration of approx. 59-60% of the baseline rate is well in excess of that expectation.

### Example 4

Several donor solutions were prepared to assess penetration of 5-Hexenoic acid across waxy cuticles of whole wheat leaves. Each donor solution comprised 1,000 ppm 5-Hexenoic acid (except where otherwise noted). Certain donor solutions included a strobilurin fungicide, namely pyraclostrobin. Such donor solutions comprised Headline® EC, a commercially available fungicide from BASF Corporation comprising pyraclostrobin. Such donor solutions comprised 236 ppm pyraclostrobin. (Pyraclostrobin is also commercially available from BASF Corporation as Headline® SC fungicide.) Certain donor solutions included an adjuvant as noted in Table 4, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of 5-Hexenoic acid in the donor solution, receptor solution, and plant leaf were analyzed as described above. The powderized leaf was mixed with acetone as a solvent.

TABLE 4

| | Pesticidal | | | | | |
|---|---|---|---|---|---|---|
| | Active | Aliphatic | | Aliphatic Acid | Penetration Relative to | Expected |
| Combination | Ingredient | Acid | Adjuvant | Penetration | Aliphatic Acid alone | penetration |
| | | 5- | | 6.8% | | |
| | | Hexenoic | | | | |
| | | acid | | | | |
| | | 5- | Biosoft | 5.1% | 75.0% | |
| | | Hexenoic | N1-5 | | | |
| | | acid | | | | |
| | | 5- | Biosoft | 5.4% | 79.4% | |
| | | Hexenoic | N1-7 | | | |
| | | acid | | | | |
| | | 5- | Biosoft | 4.9% | 72.1% | |
| | | Hexenoic | N1-9 | | | |
| | | acid | | | | |
| | Pyraclostrobin | 5- | | 9.1% | 133.8% | |
| | | Hexenoic | | | | |
| | | acid | | | | |
| 1 | Pyraclostrobin | 5- | Biosoft | 17.1% | 251.5% | 100.4% |
| | | Hexenoic | N1-5 | | | |
| | | acid | | | | |
| 2 | Pyraclostrobin | 5- | Biosoft | 14.2% | 208.2% | 106.2% |
| | | Hexenoic | N1-7 | | | |
| | | acid | | | | |
| 3 | Pyraclostrobin | 5- | Biosoft | 8.5% | 125.0% | 96.5% |
| | | Hexenoic | N1-9 | | | |
| | | acid | | | | |

Penetration of the aliphatic acid, namely 5-hexenoic acid, increased more than would be expected. For example, an estimation of the form X×Y/100, where X is the penetration of aliphatic acid in complex with an adjuvant and without pyraclostrobin, and Y is the penetration of aliphatic acid with pyraclostrobin and without the adjuvant, projects penetration in a range of approx. 97-106% of the penetration of 5-hexenoic acid alone (the baseline rate). The observed rate of penetration of approx. 125-252% of the baseline rate is well in excess of that expectation.

### Example 5

Several donor solutions were prepared to assess penetration of 3-Nonenoic acid across waxy cuticles of whole wheat leaves. Each donor solution comprised 500 ppm 3-Nonenoic acid. Certain donor solutions included an azole fungicide, namely epoxiconazole technical grade active ingredient (TGAI) fungicide, each at a rate of 50 ppm. Epoxiconazole is commercially available from MilliporeSigma, St. Louis, MO, USA, as a technical grade active ingredient. Certain donor solutions included an adjuvant as noted in Table 3, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of 3-Nonenoic in the donor solution, receptor solution, and plant leaf were analyzed as described above. The powderized leaf was mixed with acetone as a solvent.

TABLE 5

| | | | | | Penetration | |
|---|---|---|---|---|---|---|
| | Pesticidal | | | Aliphatic | Relative to | |
| | Active | Aliphatic | | Acid | Aliphatic | Expected |
| Combination | Ingredient | Acid | Adjuvant | Penetration | Acid Alone | Penetration |
| | | 3-Nonenoic | | 17.6% | | |
| | | acid | | | | |
| | | 3-Nonenoic | Biosoft N1-5 | 5.4% | 30.7% | |
| | | acid | | | | |
| | | 3-Nonenoic | Biosoft N1-7 | 3.8% | 21.6% | |
| | | acid | | | | |
| | | 3-Nonenoic | Biosoft N1-9 | 4.4% | 25.0% | |
| | | acid | | | | |
| | Epoxiconazole | 3-Nonenoic | | 23.5% | 133.5% | |
| | | acid | | | | |
| 1 | Epoxiconazole | 3-Nonenoic | Biosoft N1-5 | 13.8% | 78.4% | 41% |
| | | acid | | | | |
| 2 | Epoxiconazole | 3-Nonenoic | Biosoft N1-7 | 15.8% | 89.8% | 28.8% |
| | | acid | | | | |
| 3 | Epoxiconazole | 3-Nonenoic | Biosoft N1-9 | 20.3% | 115.3% | 33.4% |
| | | acid | | | | |

Penetration of the aliphatic acid, namely 3-nonenoic acid, increased more than would be expected. For example, an estimation of the form X×Y/100, where X is the penetration of aliphatic acid in complex with adjuvant and without epoxiconazole, and Y is the penetration of aliphatic acid with epoxiconazole and without the adjuvant, projects penetration in a range of approx. 29-41% of the penetration of 3-nonenoic acid alone (the baseline rate). The observed rate of penetration of approx. 78-115% of the baseline rate, is well in excess of that expectation.

### Example 6

Several donor solutions were prepared to assess penetration of a strobilurin fungicide active ingredient, namely pyraclostrobin, across waxy cuticles of whole wheat leaves. Each donor solution comprised Headline® EC, a commercially available fungicide from BASF Corporation comprising pyraclostrobin. Such donor solutions comprised 236 ppm pyraclostrobin. Pyraclostrobin is also commercially available in end-user product form from BASF Corporation as Headline® SC fungicide. Certain donor solutions included 1,000 ppm 5-Hexenoic acid. Certain donor solutions included an adjuvant as noted in Table 6, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of 5-Hexenoic acid in the donor solution, receptor solution, and plant leaf were analyzed as described above. The powderized leaf was mixed with acetone as a solvent.

TABLE 6

| | Pesticidal | | | Pesticidal Active | | |
|---|---|---|---|---|---|---|
| Combi- | Active | Aliphatic | | Ingredient | Penetration Relative | Expected |
| nation | Ingredient | Acid | Adjuvant | Penetration | to Active Alone (%) | Change |
| | Pyraclostrobin | | | 7.5% | | |
| | Pyraclostrobin | 5- | | 9.3% | 124.0% | |
| | | Hexenoic | | | | |
| | | acid | | | | |
| | Pyraclostrobin | | Biosoft | 7.6% | 101.4% | |
| | | | N1-5 | | | |
| | Pyraclostrobin | | Biosoft | 6.4% | 84.7% | |
| | | | N1-7 | | | |
| | Pyraclostrobin | | Biosoft | 5.2% | 69.0% | |
| | | | N1-9 | | | |
| 1 | Pyraclostrobin | 5- | Biosoft | 19.5% | 259.5% | 125.7% |
| | | Hexenoic | N1-5 | | | |
| | | acid | | | | |
| 2 | Pyraclostrobin | 5- | Biosoft | 18.9% | 250.6% | 105.0% |
| | | Hexenoic | N1-7 | | | |
| | | acid | | | | |
| 3 | Pyraclostrobin | 5- | Biosoftt | 12.4% | 165.0% | 85.6% |
| | | Hexenoic | N1-9 | | | |
| | | acid | | | | |

This surprising result shows that penetration of the strobilurin fungicide (namely pyraclostrobin) increased more than would be expected. For instance, an example estimation of the form X×Y/100, where X is the penetration of pyraclostrobin in complex with 5-Hexenoic acid and without an adjuvant and Y is the penetration of pyraclostrobin with an adjuvant and without 5-Hexenoic acid, projects penetration in a range of approx. 85% to approx. 125% of the penetration of pyraclostrobin alone (the baseline rate). The observed rate of penetration, in the range of approx. 165% to 260% of the baseline rate, is well in excess of that expectation.

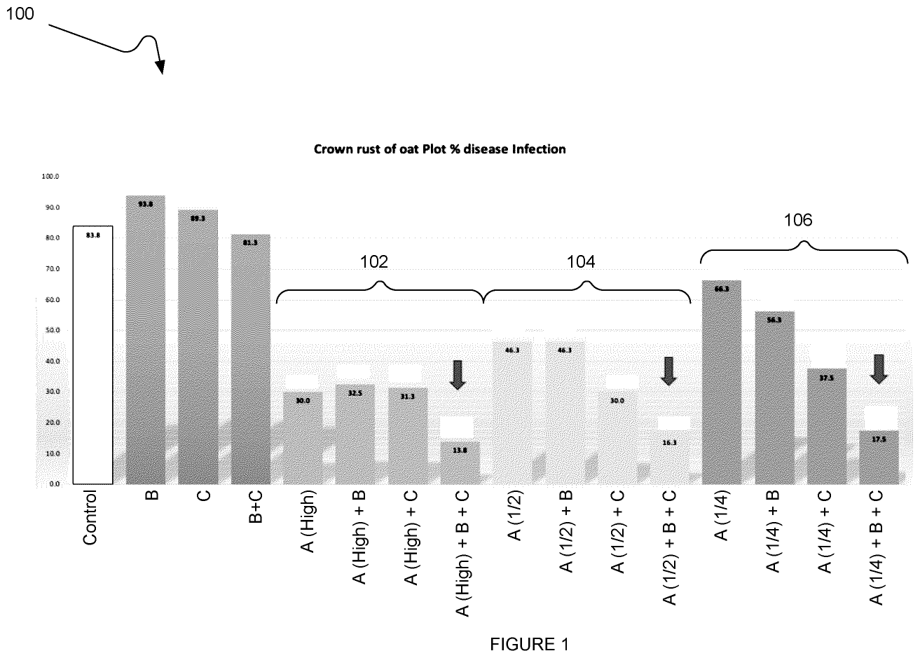

This unexpected enhancement of penetration of the pesticidal active ingredient is believed to improve efficacy of the pesticidal active ingredient. Indeed, a further field trial testing combinations of pyraclostrobin (as Headline®) with 5-Hexenoic acid and a C11 linear alcohol ethoxylate (Biosoft®) N1-5) on oat crown rust (P. coronata) demonstrated improvements to efficacy of pyraclostrobin at a range of concentrations, as shown in FIG. 1.

FIG. 1 shows a chart 100 showing rates of disease infection of crown rust (P. coronata) in plots of oats following treatment by various pesticidal compositions at various concentrations in the aforementioned field trial. In the horizontal axis of chart 100, “A” refers to the pesticidal active ingredient, namely pyraclostrobin, “B” refers to the aliphatic acid, namely 5-Hexenoic acid, and “C” refers to the ethoxylated fatty alcohol, namely C11 linear alcohol ethoxylates (and more particularly Biosoft® N1-9). For instance, “A (High)” refers to a pesticidal composition comprising the pesticidal active ingredient at the high end of the label rate, but without the aliphatic acid or the ethoxylated fatty alcohol; whereas “A (½)+B+C” refers to the composition comprising the pesticidal active ingredient at one-half the high end of the label rate (i.e. a 2-fold dilution) and also including the aliphatic acid and the ethoxylated fatty alcohol; and so on. For convenience, compositions comprising a pesticidal active ingredient, an aliphatic acid, and the ethoxylated fatty alcohol are highlighted with additional arrows.

At the high end of the label rate (0.4 L/ha Headline®, approx. 100 g/ha pyraclostrobin), shown at 102 in FIG. 1, the composition comprising pyraclostrobin, 5-Hexenoic acid, and a C11 linear alcohol ethoxylate (Biosoft® N1-9) showed improved efficacy. The same composition, diluted to a 2-fold reduced label rate (i.e. 50 g/ha pyraclostrobin) also showed improved efficacy relative to other compositions at a 2-fold reduced label rate and even relative to compositions at the high label rate (except for the composition including all three components), as shown at 104 in FIG. 1. The same composition, diluted to a 4-fold reduced label rate (i.e. 25 g/ha pyraclostrobin), also showed improved efficacy relative to other compositions at a 2-fold reduced label rate and even relative to compositions at the high label rate (except for the composition including all three components), as shown at 106 in FIG. 1.

Thus, a combination of a strobilurin fungicide (namely pyraclostrobin), an aliphatic acid (namely 5-Hexenoic acid), and an ethoxylated fatty alcohol (namely C11 linear alcohol ethoxylates, and more particularly Biosoft N1-9) increased the efficacy of the pesticidal active ingredient, even down to a 4-fold reduced rate. It is believed this improved efficacy is at least partially due to the synergistic penetration effects of such compositions, as described above.

### Example 7

Several donor solutions were prepared to assess penetration of an azole fungicide, namely epoxiconazole, across waxy cuticles of whole wheat leaves. Epoxiconazole TGAI was provided in each donor solution at a rate of 50 ppm. Epoxiconazole is available from MilliporeSigma, St. Louis, MO, USA, and Shanghai Terppon Chemical Co., Ltd., Shanghai, China as a technical grade active ingredient. Certain donor solutions comprised 500 ppm 3-Nonenoic acid. Certain donor solutions included an adjuvant as noted in Table 7, each at a rate of 1,000 ppm. In this example, the adjuvant tested was a non-ionic surfactant comprising a formulation of C11 linear alcohol ethoxylates (available from Stepan Company of Northfield, IL as Biosoft® N1-9).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of 3-Nonenoic acid in the donor solution, receptor solution, and plant leaf were analyzed as described above. The powderized leaf was mixed with acetone as a solvent.

TABLE 7

| | Pesticidal | | | Pesticidal Active | | |
|---|---|---|---|---|---|---|
| Combi- | Active | Aliphatic | | Ingredient | Penetration Relative | Expected |
| nation | Ingredient | Acid | Adjuvant | Penetration | to Active Alone (%) | Change |
| | Epoxiconazole | | | 18.2% | | |
| | Epoxiconazole | 3- | | 23.6% | 129.8% | |
| | | Nonenoic | | | | |
| | | acid | | | | |
| | Epoxiconazole | | Biosoft | 13.0% | 71.4% | |
| | | | N1-9 | | | |
| 3 | Epoxiconazole | 3- | Biosoft | 28.2% | 155.0% | 92.7% |
| | | Nonenoic | N1-9 | | | |
| | | acid | | | | |

This surprising result shows that penetration of the azole (namely epoxiconazole) increased more than would be expected under an additive model. For example, an estimation (of the form X×Y/100, where X is the penetration of epoxiconazole in complex with 3-Nonenoic acid and without an adjuvant and Y is the penetration of epoxiconazole with an adjuvant and without 3-Nonenoic acid, projects penetration of approx. 93% of the penetration of epoxiconazole alone (the baseline rate). The observed rate of penetration, approx. 155% of the baseline rate, is well in excess of the expectation.

### Example 8

Several donor solutions were prepared to assess penetration of a strobilurin fungicide active ingredient, namely pyraclostrobin, across waxy cuticles of whole wheat leaves. Each donor solution comprised Headline® SC, a commercially available fungicide from BASF Corporation comprising pyraclostrobin. Such donor solutions comprised 236 ppm pyraclostrobin. Certain donor solutions included an aliphatic acid, namely 5-Hexenoic acid. Such donor solutions comprised 1,000 ppm 5-Hexenoic acid. Certain donor solutions included an adjuvant as noted in Table 8, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole wheat leaves were covered using a guard with a 5 mm by 15 mm aperture (to account for leaf geometry) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of pyraclostrobin in the donor solution, receptor solution, and plant leaf were analyzed as described above. The powderized leaf was mixed with acetone as a solvent.

TABLE 8

| | Pesticidal | | | Pesticidal Active | Penetration | |
|---|---|---|---|---|---|---|
| Combi- | Active | Aliphatic | | Ingredient | Relative to Active | Expected |
| nation | Ingredient | Acid | Adjuvant | Penetration | Alone | Penetration |
| | Pyraclostrobin | | | 7.1% | | |
| | Pyraclostrobin | 5- | | 3.7% | 52.1% | |
| | | Hexenoic | | | | |
| | | acid | | | | |
| | Pyraclostrobin | | Biosoft | 7.7% | 108.5% | |
| | | | N1-5 | | | |
| | Pyraclostrobin | | Biosoft | 8.6% | 111.7% | |
| | | | N1-7 | | | |
| | Pyraclostrobin | | Biosoft | 5.4% | 76.1% | |
| | | | N1-9 | | | |
| 1 | Pyraclostrobin | 5- | Biosoft | 15.0% | 211.3% | 56.5% |
| | | Hexenoic | N1-5 | | | |
| | | acid | | | | |
| 2 | Pyraclostrobin | 5- | Biosoft | 18.7% | 263.4% | 58.2% |
| | | Hexenoic | N1-7 | | | |
| | | acid | | | | |
| 3 | Pyraclostrobin | 5- | Biosoft | 10.7% | 150.7% | 39.6% |
| | | Hexenoic | N1-9 | | | |
| | | acid | | | | |

Penetration of the strobilurin fungicide, namely pyraclostrobin, increased more than would be expected. For example, an estimation of the form X×Y/100, where X is the penetration of pyraclostrobin in complex with 5-Hexenoic acid and without an adjuvant and Y is the penetration of pyraclostrobin with an adjuvant and without 5-Hexenoic acid, projects penetration in a range of approx. 40% to approx. 58% of the penetration of pyraclostrobin alone (the baseline rate). The observed rate of penetration, in the range of 151% to 263% of the baseline rate, is well in excess of that expectation.

### Example 9

Several donor solutions were prepared to assess penetration of an azole fungicide active ingredient, namely prothioconazole, across waxy cuticles of whole soybean leaves. Each donor solution comprised Proline®, a commercially available fungicide from Bayer CropScience comprising prothioconazole. Such donor solutions comprised 615 ppm prothioconazole. Certain donor solutions included an aliphatic acid, namely trans-3-Hexenoic acid. Such donor solutions comprised 1,500 ppm trans-3-Hexenoic acid. Certain donor solutions included an adjuvant as noted in Table 9, each at a rate of 1,000 ppm. In this example, the adjuvants tested were non-ionic surfactants comprising C11 linear alcohol ethoxylates (available from Stepan Company of Northfield, IL as Biosoft® N1-5, Biosoft® N1-7, and Biosoft® N1-9).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of prothioconazole in the donor solution, receptor solution, and plant leaf were analyzed as described above. The powderized leaf was mixed with methanol as a solvent.

TABLE 9

| | Pesticidal | | | Pesticidal Active | Penetration | |
|---|---|---|---|---|---|---|
| Combi- | Active | Aliphatic | | Ingredient | Relative to Active | Expected |
| nation | Ingredient | Acid | Adjuvant | Penetration | Alone | Penetration |
| | Prothioconazole | | | 2.5% | | |
| | Prothioconazole | trans-3- | | 1.4% | 56% | |
| | | Hexenoic | | | | |
| | | acid | | | | |
| | Prothioconazole | | Biosoft | 20.2% | 808.0% | |
| | | | N1-5 | | | |
| | Prothioconazole | | Biosoft | 9.4% | 376.0% | |
| | | | N1-7 | | | |
| | Prothioconazole | | Biosoft | 6.4% | 256.0% | |
| | | | N1-9 | | | |
| 1 | Prothioconazole | trans-3- | Biosoft | 15.1% | 604.0% | 452.5% |
| | | Hexenoic | N1-5 | | | |
| | | acid | | | | |
| 2 | Prothioconazole | trans-3- | Biosoft | 11.6% | 464.0% | 210.6% |
| | | Hexenoic | N1-7 | | | |
| | | acid | | | | |
| 3 | Prothioconazole | trans-3- | Biosoft | 9.5% | 380.0% | 143.4% |
| | | Hexenoic | N1-9 | | | |
| | | acid | | | | |

Penetration of the triazole fungicide, namely prothioconazole, increased more than would be expected. For example, an estimation of the form X×Y/100, where X is the penetration of prothiocoanzole in complex with trans-3-hexenoic acid and without an adjuvant, and Y is the penetration of prothioconazole with an adjuvant and without trans-3-hexenoic acid, projects penetration in a range of approx. 143-452% of the penetration of prothioconazole alone (the baseline rate). The observed rate of penetration of approx. 380-604% of the baseline rate, is well in excess of that expectation.

### Example 10

Several donor solutions were prepared to assess penetration of an azole fungicide, namely prothioconazole, across waxy cuticles of whole soybean leaves. Each donor solution comprised Proline®), a commercially available fungicide from Bayer CropScience comprising prothioconazole. Such donor solutions comprised 615 ppm prothioconazole. Certain donor solutions included 1,500 ppm trans-3-Hexenoic acid. Certain donor solutions included an adjuvant as noted in Table 10, each at a rate of 31.1 ppm. In this example, the adjuvant tested was a non-ionic surfactant comprising an alky aryl polyethoxylate, namely nonylphenoxy polyethoxy ethanol (available from Syngenta as Agral®) 90).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of prothioconazole in the donor solution, receptor solution, and plant leaf were analyzed as described above. The powderized leaf was mixed with methanol as a solvent.

TABLE 10

| | | | | Pesticidal | | |
|---|---|---|---|---|---|---|
| | Pesticidal | | | Active | Penetration | |
| | Active | Aliphatic | | Ingredient | Relative to Active | Expected |
| Combination | Ingredient | Acid | Adjuvant | Penetration | Alone (%) | Change |
| | Prothioconazole | | | 1.1% | | |
| | Prothioconazole | trans-3- | | 3.7% | 336.4% | |
| | | Hexenoic | | | | |
| | | acid | | | | |
| | Prothioconazole | | Agral 90 | 1.8% | 163.6% | |
| 1 | Prothioconazole | trans-3- | Agral 90 | 6.9% | 627.3% | 550.4% |
| | | Hexenoic | | | | |
| | | acid | | | | |

Penetration of the triazole fungicide (namely prothiocoanzole) increased more than would be expected. For instance, an example estimation of the form X×Y/100, where X is the penetration of prothiocoanzole in complex with trans-3-Hexenoic acid and without an adjuvant and Y is the penetration of prothioconazole with an adjuvant and without trans-3-Hexenoic acid, projects penetration of approx. 550% of the penetration of prothioconazole alone (the baseline rate). The observed rate of penetration of approx. 627% of the baseline rate is well in excess of that expectation.

### Example 11

Several donor solutions were prepared to assess penetration of trans-3-Hexenoic acid across waxy cuticles of whole soybean leaves. Each donor solution comprised 1,500 ppm trans-3-Hexenoic acid (except where otherwise noted). Certain donor solutions included an azole fungicide, namely prothioconazole. Such donor solutions comprised Proline®, a commercially available fungicide from Bayer CropScience comprising prothioconazole. Such donor solutions comprised 615 ppm prothioconazole. Certain donor solutions included an adjuvant as noted in Table 11, each at a rate of 31.1 ppm. In this example, the adjuvant tested was a non-ionic surfactant comprising an alky aryl polyethoxylate, namely nonylphenoxy polyethoxy ethanol (available from Syngenta as Agral® 90).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of trans-3-Hexenoic acid in the donor solution, receptor solution, and plant leaf were analyzed as described above. The powderized leaf was mixed with methanol as a solvent.

TABLE 11

| | Pesticidal Active | | | Aliphatic Acid | Penetration Relative to |
|---|---|---|---|---|---|
| Combination | Ingredient | Aliphatic Acid | Adjuvant | Penetration | Complex (%) |
| | | trans-3- | | 13.7% | |
| | | Hexenoic acid | | | |
| | Prothioconazole | trans-3- | | 15.2% | |
| | | Hexenoic acid | | | |
| 1 | Prothioconazole | trans-3- | Agral | 19.9% | 130.9% |
| | | Hexenoic acid | 90 | | |

This result shows that there is a 1.3-fold increase in penetration of aliphatic acid in combination with prothioconazole when Agral 90 is added. This is expected to increase the bioavailability for complex formation with prothioconazole within the plant.

### Example 12

Several donor solutions were prepared to assess penetration of an azole fungicide, namely prothioconazole, across waxy cuticles of whole soybean leaves. Each donor solution comprised Proline®, a commercially available fungicide from Bayer CropScience comprising prothioconazole. Such donor solutions comprised 615 ppm prothioconazole. Certain donor solutions included 1,500 ppm trans-3-Hexenoic acid. Certain donor solutions included an adjuvant as noted in Table 12, each at a rate of 31.3 ppm. In this example, the adjuvant tested was a non-ionic surfactant comprising an alky aryl polyethoxylate, namely t-octylphenoxy polyethoxy ethanol (available from Sigma-Aldrich as Triton™ X-100).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of prothioconazole in the donor solution, receptor solution, and plant leaf were analyzed as described above. The powderized leaf was mixed with methanol as a solvent.

TABLE 12

| | | | | Pesticidal | | |
|---|---|---|---|---|---|---|
| | Pesticidal | | | Active | Penetration | |
| | Active | Aliphatic | | Ingredient | Relative to Active | Expected |
| Combination | Ingredient | Acid | Adjuvant | Penetration | Alone (%) | Change |
| | Prothioconazole | | | 0.7% | | |
| | Prothioconazole | Trans-3- | | 1.9% | 271.4% | |
| | | Hexenoic | | | | |
| | | acid | | | | |
| | Prothioconazole | | Triton X-100 | 1.1% | 157.1% | |
| 1 | Prothioconazole | Trans-3- | Triton X-100 | 4.1% | 585.7% | 426.4% |
| | | Hexenoic | | | | |
| | | acid | | | | |

Penetration of the triazole fungicide (namely prothiocoanzole) increased more than would be expected. For instance, an example estimation of the form X×Y/100, where X is the penetration of prothiocoanzole in complex with trans-3-Hexenoic acid and without an adjuvant, and Y is the penetration of prothioconazole with an adjuvant and without trans-3-Hexenoic acid) projects penetration in a range of approx. 426% of the penetration of prothioconazole alone (the baseline rate). The observed rate of penetration of approx. 586% of the baseline rate, is well in excess of that expectation.

### Example 13

Several donor solutions were prepared to assess penetration of trans-3-Hexenoic acid across waxy cuticles of whole soybean leaves. Each donor solution comprised 1,500 ppm trans-3-Hexenoic acid. Certain donor solutions included Proline®), a commercially available fungicide from Bayer CropScience comprising prothioconazole. Such donor solutions comprised 615 ppm prothioconazole. Certain donor solutions included an adjuvant as noted in Table 12, each at a rate of 31.3 ppm. In this example, the adjuvant tested was a non-ionic surfactant comprising an alky aryl polyethoxylate, namely t-octylphenoxy polyethoxy ethanol (available from Sigma-Aldrich as Triton™ X-100).

The whole soybean leaves were cut into a roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of trans-3-Hexenoic acid in the donor solution, receptor solution, and plant leaf were analyzed as described above. The powderized leaf was mixed with methanol as a solvent.

TABLE 13

| | Pesticidal Active | | | Aliphatic Acid | Penetration Relative to |
|---|---|---|---|---|---|
| Combination | Ingredient | Aliphatic Acid | Adjuvant | Penetration | Complex (%) |
| | | trans-3- | | 13.7% | |
| | | Hexenoic acid | | | |
| | Prothioconazole | trans-3- | | 8.6% | |
| | | Hexenoic acid | | | |
| | | trans-3- | Triton | | |
| 1 | Prothioconazole | Hexenoic acid | X-100 | 12.3% | 143.0% |

These results show a decrease of aliphatic acid penetration when combined with prothioconazole: without being bound by theory, this is believed to be at least partially attributable to complex formation between the aliphatic acid and active ingredient. There is an approx. 1.4-fold increase in penetration of the aliphatic acid in combination with prothioconazole when Triton X-100 is added. This is expected to increase the bioavailability of the aliphatic acid for complex formation with prothioconazole within the plant.

### Example 14

Several donor solutions were prepared to assess penetration of a strobilurin fungicide, namely azoxystrobin, across waxy cuticles of whole soybean leaves. Each donor solution comprised Quadris®, a commercially available fungicide from Syngenta Crop Protection comprising azoxystrobin. Such donor solutions comprised 343.5 ppm azoxystrobin. Certain donor solutions included 1,500 ppm trans-2-Hexenoic acid. Certain donor solutions included an adjuvant as noted in Table 14, each at a rate of 31.3 ppm. In this example, the adjuvant tested was a non-ionic surfactant comprising methylated seed oil (containing methyl esters of various C16-18 fatty acids) and ethoxy (7) tridecanol: this adjuvant is available from Bayer CropScience as Mero®.

The whole soybean leaves were cut into roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of azoxystrobin in the donor solution, receptor solution, and plant leaf were analyzed as described above. The powderized leaf was mixed with methanol as a solvent.

TABLE 14

| | | | | Pesticidal | | |
|---|---|---|---|---|---|---|
| | Pesticidal | | | Active | Penetration | |
| | Active | Aliphatic | | Ingredient | Relative to Active | Expected |
| Combination | Ingredient | Acid | Adjuvant | Penetration | Alone (%) | Change |
| | Azoxystrobin | | | 0.7% | | |
| | Azoxystrobin | trans-2 | | 0.5% | 71.4% | |
| | | Hexenoic | | | | |
| | | acid | | | | |
| | Azoxystrobin | | Mero | 0.8% | 114.3% | |
| 1 | Azoxystrobin | trans-2 | Mero | 1.4% | 200.0% | 81.6% |
| | | Hexenoic | | | | |
| | | acid | | | | |

This surprising result shows that penetration of the strobilurin fungicide (namely azoxystrobin) increased more than would be expected. For instance, an example estimation of the form X×Y/100, where X is the penetration of azoxystrobin in complex with trans-2-Hexenoic acid and without an adjuvant and Y is the penetration of azoxystrobin with an adjuvant and without trans-2-Hexenoic acid, projects penetration of approx. 82% of the penetration of azoxystrobin alone (the baseline rate). The observed rate of penetration of 200% of the baseline rate, is well in excess of that expectation.

### Example 15

Several donor solutions were prepared to assess penetration of trans-2-Hexenoic acid across waxy cuticles of whole soybean leaves. Each donor solution comprised 1,500 ppm trans-2-Hexenoic acid. Certain donor solutions included a strobilurin fungicide, namely azoxystrobin. Such donor solutions comprised Quadris®, a commercially available fungicide from Syngenta Crop Protection comprising azoxystrobin. Such donor solutions comprised 343.5 ppm azoxystrobin. Certain donor solutions included an adjuvant as noted in Table 15, each at a rate of 31.3 ppm. In this example, the adjuvant tested was a non-ionic surfactant comprising methylated seed oil (containing methyl esters of various C16-18 fatty acids) and ethoxy (7) tridecanol; this adjuvant is available from Bayer CropScience as Mero®).

The whole soybean leaves were cut into roughly circular shapes with a ˜28 mm diameter (avoiding cutting major veins) and overlaid on a 15 mm aperture at the joint of the Franz cell. 3 mL of donor solution was loaded into the donor chamber. 12 mL of receptor solution was loaded into the receptor chamber. The receptor solution was a mixture of methanol and distilled water in a 1:1 ratio. The permeation period was 24 hours. The quantities of trans-2-Hexenoic acid in the donor solution, receptor solution, and plant leaf were analyzed as described above. The powderized leaf was mixed with methanol as a solvent.

TABLE 15

| | Pesticidal Active | | | Aliphatic Acid | Penetration Relative to |
|---|---|---|---|---|---|
| Combination | Ingredient | Aliphatic Acid | Adjuvant | Penetration | Complex (%) |
| | | trans-2- | | 13.2% | |
| | | Hexenoic acid | | | |
| | Azoxystrobin | trans-2 | | 10.6% | |
| | | Hexenoic acid | | | |
| 1 | Azoxystrobin | trans-2 | Mero | 35.2% | 332.1% |
| | | Hexenoic acid | | | |

Addition of the Mero adjuvant increased the leaf cuticle penetration of trans-2-Hexenoic acid by approx. 3.3-fold relative to the complex without the adjuvant. This is expected to aid in formation of complexes of the pesticidal active ingredient and the aliphatic acid within the plant.

### Concluding Generalities

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A pesticidal composition comprising:
a pesticidal active ingredient selected from the group consisting of: an azole fungicide, a strobilurin fungicide, and combinations thereof;
a saturated or unsaturated aliphatic acid; and
a non-ionic surfactant effective to increase penetration of at least one of the pesticidal active ingredient and the saturated or unsaturated aliphatic acid across a waxy plant cuticle.

2. The pesticidal composition according to claim 1 wherein the pesticidal active ingredient comprises azoxystrobin, pyraclostrobin, or a triazole fungicide, wherein the triazole fungicide optionally comprises prothioconazole and epoxiconazole.

3. (canceled)

4. (canceled)

5. (canceled)

6. (canceled)

7. The pesticidal composition according to claim 1 wherein the pesticidal active ingredient is hydrophobic.

8. The pesticidal composition according to claim 1 wherein the non-ionic surfactant is effective to synergistically increase penetration of at least one of the pesticidal active ingredient and the saturated or unsaturated aliphatic acid across the waxy plant cuticle.

9. The pesticidal composition according to claim 1 wherein the non-ionic surfactant comprises an alky aryl polyethoxylate, optionally at least one of: nonylphenoxy polyethoxy ethanol and t-octylphenoxy polyethoxy ethanol.

10. (canceled)

11. The pesticidal composition according to claim 1 wherein the non-ionic surfactant comprises an ethoxylated fatty alcohol, optionally a linear alcohol ethoxylate, further optionally a C11 linear alcohol ethoxylate, wherein the C11 linear alcohol ethoxylate is optionally a Biosoft® N1 series surfactant, optionally Biosoft® N1-5, Biosoft® N1-7, and Biosoft® N1-9.

12. (canceled)

13. (canceled)

14. (canceled)

15. (canceled)

16. The pesticidal composition according to claim 1 wherein the saturated or unsaturated aliphatic acid comprises a C4-C12 saturated or unsaturated aliphatic acid.

17. The pesticidal composition according to claim 1 wherein the saturated or unsaturated aliphatic acid comprises a C6-C10 saturated or unsaturated aliphatic acid, comprising at least one of: (a) a trans-2, trans-3, trans-4, trans-5, trans-6, trans-7, trans-8, and trans-9, cis-2, cis-3, cis-4, cis-5, cis-6, cis-7, cis-8, cis-9 unsaturated bond; (b) a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, and a decynoic acid, optionally wherein the C6-C10 saturated or unsaturated aliphatic acid comprises at least one of: trans-2-hexenoic acid, trans-3-hexenoic acid, 5-hexenoic acid, and 3-nonenoic acid.

18. (canceled)

19. The pesticidal composition according to claim 1 wherein the saturated or unsaturated aliphatic acid is in a range of at least one of: 10 to 10,000, 100 to 10,000, 500 to 10,000, 1,000 to 10,000, 1,500 to 10,000, 10 to 9,000, 100 to 9,000, 500 to 9,000, 1,000 to 9,000, 1,500 to 9,000, 10 to 8,000, 100 to 8,000, 500 to 8,000, 1,000 to 8,000, 1,500 to 8,000, 10 to 7,000, 100 to 7,000, 500 to 7,000, 1,000 to 7,000, 1,500 to 7,000, 10 to 6,000, 100 to 6,000, 500 to 6,000, 1,000 to 6,000, 1,500 to 6,000, 10 to 5,000, 100 to 5,000, 500 to 5,000, 1,000 to 5,000, 1,500 to 5,000, 10 to 4,000, 100 to 4,000, 500 to 4,000, 1,000 to 4,000, 1,500 to 4,000, 10 to 3,000, 100 to 3,000, 500 to 3,000, 1,000 to 3,000, 1,500 to 3,000, 10 to 2,500, 100 to 2,500, 500 to 2,500, 1,000 to 2,500, 1,500 to 2,500, 10 to 2,000, 100 to 2,000, 500 to 2,000, 1,000 to 2,000, 1,500 to 2,000, 10 to 1,500, 100 to 1,500, 500 to 1,500, 1,000 to 1,500, 10 to 1,000, 100 to 1,000, 500 to 1,000, 10 to 500, and 100 to 500, ppm of the pesticidal composition, optionally wherein the saturated or unsaturated aliphatic acid is in a range of 500 to 3,500 ppm of the pesticidal composition, further optionally wherein the saturated or unsaturated aliphatic acid is in a range of 500 to 1,500 ppm of the pesticidal composition.

20. (canceled)

21. (canceled)

22. The pesticidal composition according to claim 1 wherein a concentration ratio of pesticidal active ingredient to saturated or unsaturated aliphatic acid is in a range of about 1:100 to 0.1:1 by weight, wherein the concentration ratio of pesticidal active ingredient to saturated or unsaturated aliphatic acid is in a range of about 1:10 to 1:1 by weight, wherein a concentration ratio of saturated or unsaturated aliphatic acid to non-ionic surfactant is in a range of about 1:10 to 100:1 by weight, or wherein the concentration ratio of saturated or unsaturated aliphatic acid to non-ionic surfactant is in a range of about 1:1 to 10:1 by weight.

23. (canceled)

24. (canceled)

25. (canceled)

26. The pesticidal composition according to claim 1 wherein the pesticidal composition comprises at least one of: a solution, and a suspension concentrate; wherein the pesticidal composition comprises at least one of: an emulsion and an emulsifiable concentrate, the pesticidal composition further comprising: an emulsifier; or wherein the non-ionic surfactant increases penetration of at least one of: the pesticidal active ingredient and the saturated or unsaturated aliphatic acid through a waxy cuticle of the at least one plant, wherein the at least one plant optionally comprises at least one of: wheat, soy, and cabbage.

27. (canceled)

28. (canceled)

29. (canceled)

30. A method for making a pesticidal composition, the method comprising forming the pesticidal composition by combining:
a pesticidal active ingredient selected from the group consisting of: an azole fungicide, a strobilurin fungicide, and combinations thereof;
a saturated or unsaturated aliphatic acid; and
a non-ionic surfactant effective to increase penetration of at least one of the pesticidal active ingredient and the saturated or unsaturated aliphatic acid across a waxy plant cuticle.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. The method according to claim 30 comprising mixing the saturated or unsaturated aliphatic acid with a pre-mixed mixture of the pesticidal active ingredient and the ethoxylated fatty alcohol surfactant; mixing a pre-mixed mixture of the saturated or unsaturated aliphatic acid and the non-ionic surfactant with the pesticidal active ingredient, or mixing a pre-mixed mixture of the saturated or unsaturated aliphatic acid and pesticidal active ingredient with the ethoxylated fatty alcohol surfactant.

51. (canceled)

52. (canceled)

53. The method according to claim 30 comprising forming a solution comprising the pesticidal active ingredient, the saturated or unsaturated aliphatic acid, and the ethoxylated fatty alcohol surfactant; forming at least one of: an emulsion and an emulsifiable concentrate comprising the pesticidal active ingredient, the saturated or unsaturated aliphatic acid, and the ethoxylated fatty alcohol surfactant; or forming a suspension concentrate comprising the pesticidal active ingredient, the saturated or unsaturated aliphatic acid, and the ethoxylated fatty alcohol surfactant.

54. (canceled)

55. (canceled)

56. The method according to claim 41 comprising selecting the ethoxylated fatty alcohol based on operability of the ethoxylated fatty alcohol to increase penetration of the saturated or unsaturated aliphatic acid in the presence of the pesticidal active ingredient through a waxy cuticle of the at least one plant.

57. The method according to claim 56 wherein the ethoxylated fatty alcohol is operable to synergistically increase penetration of the saturated or unsaturated aliphatic acid in the presence of the pesticidal active ingredient through a waxy cuticle of the at least one plant, wherein the plant optionally comprises at least one of: wheat, soy, and cabbage.

58. (canceled)

59. An adjuvant for a pesticidal composition, the adjuvant comprising:
a saturated or unsaturated aliphatic acid; and
a non-ionic surfactant effective to increase penetration of at least one of a pesticidal active ingredient and the saturated or unsaturated aliphatic acid across a waxy plant cuticle when combined with the pesticidal active ingredient.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. The adjuvant according to claim 59 wherein the adjuvant comprises a concentrate and the saturated or unsaturated aliphatic acid is in a range of 1% to 90% of the adjuvant.

72.-97. (canceled)

98. A method for making a pesticidal composition according to claim 30 wherein forming the pesticidal composition comprises combining the adjuvant of claim 59 with the pesticidal active ingredient.

99. Use of the adjuvant of claim 59 to control at least one plant pest of at least one plant by forming a pesticidal composition comprising the adjuvant and applying the pesticidal composition to the at least one plant, optionally wherein the at least one plant is at least one of: wheat, soy, and cabbage.

100.-114. (canceled)
